(19) United States
(12) Patent Application Publication
(10) Pub. No.: US 2026/0017173 A1
(43) Pub. Date: Jan. 15, 2026

(54) System and Method for Using Artificial Intelligence (AI) to Recommend Solutions to Issues and Fix Issues in Source Code

(71) Applicant: MICRO FOCUS LLC, WILMINGTON, DE (US)

(72) Inventors: ADARSH PANDEY, BANGALORE (IN); NAGARJUN SHROFF, BANGALORE (IN); MANOHAR CHAMARAJU, BANGALORE (IN); SATYAJIT KATTI, BANGALORE (IN)

(73) Assignee: MICRO FOCUS LLC, WILMINGTON, DE (US)

(21) Appl. No.: 18/772,069

(22) Filed: Jul. 12, 2024

(51) Int. Cl. G06F 11/36; G06N 3/08

(52) U.S. Cl. CPC G06F 11/3624; G06N 3/08

(57) ABSTRACT

An AI algorithm is trained using a training set. The training set is a set of training sentence encodings of issues associated with different components of source code. For example, the set of training sentence encodings of issues may be floating point vectors. A new identified issue associated with a base of source code is received. Text associated with the new identified issue is converted into a set of one or more sentence encodings. The set of one or more sentence encodings are provided to the trained AI algorithm. In response to providing set of one or more sentence encodings to the trained AI algorithm, an output from the AI algorithm that identifies one or more files that are likely a cause of the new identified issue is received. The one or more files that are the likely cause of the new identified issue are displayed to a user.

### FIELD

The disclosure relates generally to managing issues in source code and particularly improving the process of generating fixed source code in a more efficient manner.

### BACKGROUND

One of the issues with source code development is that software applications have become incredibly complex. For example, with the advent of AI algorithms that generate source code, extremely large and complex software applications are now the norm. The AI generated source code may still have many existing issues (e.g., bugs, unoptimized source code, malware, etc.) that have not been identified. As a result, it has become increasingly difficult to identify and locate where issues reside in these extremely complex software applications.

In addition, the ability to fix issues in these extremely complex software applications has become increasingly difficult. This is due not only to the size of the software applications, but also because the user interfaces for identifying and correcting issues are located in different software programs that do not correlate the identified issues with where the issues reside in the source code or help with determining how to fix the issues.

As a result, these issues can result in much longer development cycles and software applications that have misidentified issues, have unknown issues, have software vulnerabilities, and are unstable. Moreover, because these issues are not always identified, it can lead to security breaches, unreliable software, slow running software, delayed releases, and/or the like.

### SUMMARY

These and other needs are addressed by the various embodiments and configurations of the present disclosure. The present disclosure can provide a number of advantages depending on the particular configuration. These and other advantages will be apparent from the disclosure contained herein.

An AI algorithm is trained using a training set. The training set is a set of training sentence encodings of issues associated with different components of source code. For example, the set of training sentence encodings of issues may be floating point vectors. A new identified issue associated with a base of source code is received. Text associated with the new identified issue is converted into a set of one or more sentence encodings. The set of one or more sentence encodings are provided to the trained AI algorithm. In response to providing set of one or more sentence encodings to the trained AI algorithm, an output from the AI algorithm that identifies one or more files that are likely a cause of the new identified issue is received. The one or more files that are the likely cause of the new identified issue are displayed to a user.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As defined herein and in the claims, the term “issue” and/or “issues” when relating to source code may comprise any of the following: bugs, unoptimized source code, malware, vulnerabilities, improperly designed user interfaces, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for using AI to recommend solutions to issues and to fix issues in source code.

FIG. 2 is a block diagram of a second illustrative system for using AI to recommend solutions to issues and to fix issues in source code.

FIG. 3 is a block diagram of a third illustrative system for training a code management AI algorithm.

FIG. 4 is a flow diagram of a process for using AI to recommend solutions to issues and to fix issues in source code.

FIG. 5 is a flow diagram of a process for using AI to recommend solutions to issues and to fix issues in source code along with identifying fixes and potential developers to fix the source code.

FIG. 6 is diagram of a user interface that allows a developer to efficiently identify solutions to issues and to fix issues in source code.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

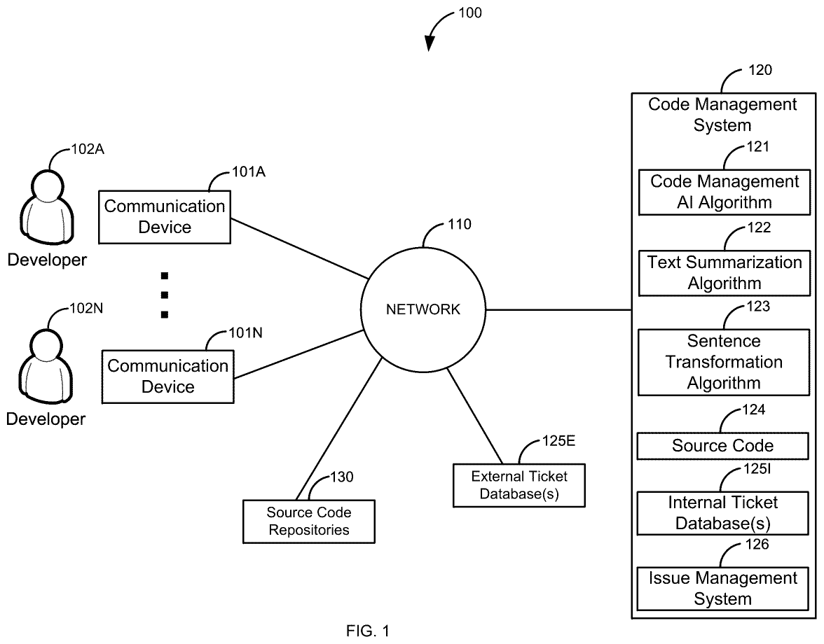

FIG. 1 is a block diagram of a first illustrative system 100 for using AI to recommend solutions to issues and to fix issues in source code 124. The first illustrative system 100 comprises communication devices 101A-101N, a network 110, a code management system 120, external ticket databases 125E, and source code repositories 130.

In addition, developers 102A-102N are shown for convenience. The developers 102A-102N may be any person who is associated with the software development process, such as a software engineer, a tester, a manager, a project manager, a user of a software application, and/or the like.

The communication devices 101A-101N can be or may include any user device that can communicate on the network 110 for managing source code 125, such as a Personal Computer (PC), a cellular telephone, a Personal Digital Assistant (PDA), a tablet device, a notebook device, a laptop computer, a smartphone, and/or the like. As shown in FIG. 1, any number of communication devices 101A-101N may be connected to the network 110, including only a single communication device 101.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The code management system 120 may be any device that is used to manage the development of software/firmware, such as a development server, as software tracking system, a code management server, and/or the like. The code management system 120 further comprises a code management AI algorithm 121, a text summarization algorithm 122, a sentence transformation algorithm 123, source code 124, internal ticket database(s) 125I, and an issue management system 126.

The code management AI algorithm 121 may be any AI algorithm that can be trained using information from the ticket database(s) 125 and/or other sources, such as a supervised machine learning algorithm, an unsupervised machine learning algorithm, a generative AI algorithm, a neural network, and/or the like. For example, the code management AI algorithm 121 may be a neural network AI algorithm.

The internal in the ticket database 125I (or 125E) may include information about an issue, a description of the issue, what type of problem the issue causes, potential fixes, previous fixes, comments about fixes in the source code 124, a time when the issue was identified, versions of software that the issue is associated with, source code repositories 130 (e.g., GitHub) associated with the source code 124 that has the issue, a revision history of the issue, different source code file(s) affected by the issue, when a ticket was opened, when a ticket was closed, an expended date to fix the issue, a priority of the issue, and/or the like.

The information in the ticket database 125I (or 125E) may include what is called a pull request. The pull request has the information associated with a ticket. A ticket is associated with an identified issue. There may be multiple pull requests associated with a ticket. For example, an issue may be applicable to different source code repositories 130 and/or the source code 124.

The text summarization algorithm 122 may be any type of algorithm that can be used to summarize text, such as an extractive summarization algorithm, an abstractive summarization algorithm, a BART model, the Facebook® summarization model, and/or the like. The text summarization algorithm 122 is used to summarize information that is in the ticket database 125/source code 124, and/or the like.

The sentence transformation algorithm 123 may be any algorithm that can be used to transform text summarized by the text summarization algorithm 122 into sentence encodings. The sentence encodings are information that is used as an input into the code management AI algorithm 121. For example, the text summarization algorithm 122 may be a vector AI algorithm (e.g., an algorithm that generates floating point vectors, integer vectors, and/or the like), an all-mpnet-base algorithm, a string comparison algorithm, a pattern matching algorithm (e.g., regex based), and/or the like.

The source code 124 may be any source code 124 that is used to develop a software/firmware application. The source code 124 may comprise multiple source code files, multiple source code bases, open-source code, proprietary source code, third party source code, and/or the like. The source code 124 may be written in different programming languages, such as, Java, C, C++, C##, Pearl, JavaScript, Hyper Text Markup Language (HTML), Cobol, and/or the like.

The internal ticket database 125I may be any internal application that is used to track issues in the source code 124. The internal database 125I is typically a separate database that is used by the developers 102A-102N to manage and track issues associated with the source code 124, such as Jira, Bugzilla, Backlog, Clickup, Mantis Bug Tracker, BugHerd, and/or the like.

The issue management system 126 is used to manage the code management AI algorithm 121, the text summarization algorithm 122, the sentence transformation algorithm 123, the source code 124, and the internal ticket database(s) 125I to identify and manage issues in the source code 124. The issue management system 126 is used to provide more efficient management of the issue tracking process.

The external ticket database 125E is similar to the internal ticket database 125I. However, the external ticket database 125E is used to track issues for external source code 124/source code repositories 130. For example, the external ticket database 125E may track open-source components (e.g., stored in GetHub®). The information in the external ticket database 125E can be used to train the code management AI algorithm 121.

The source code repositories 130 may be any system that has source code 124 that may be used to train the code management AI algorithm 121. In one embodiment, the external ticket database(s) 125E may be part of the source code repositories 130. For example, the external ticket database 125E may be part of a source code repository 130, such as GitHub®.

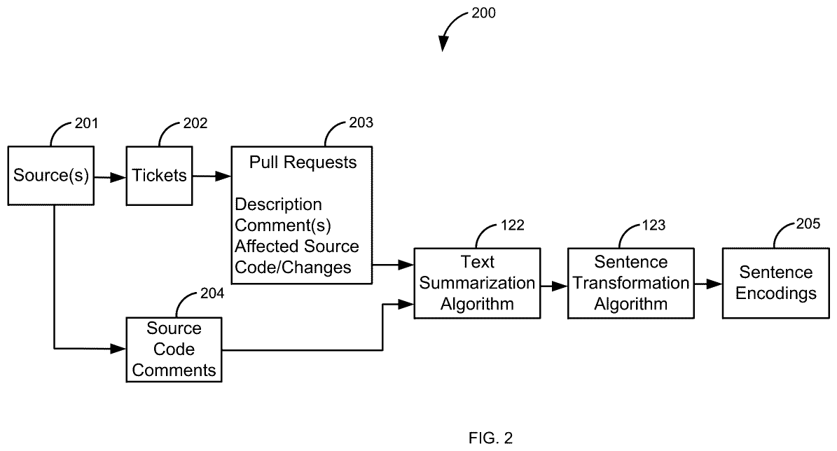

FIG. 2 is a block diagram of a second illustrative system 200 for using AI to recommend solutions to issues and to fix issues in source code 124. The second illustrative system 200 comprises source(s) 201, tickets 202, pull requests 203, source code comments 204, the text summarization algorithm 122, the sentence transformation algorithm 123, and sentence encodings 205.

The source(s) 201 may be any source of information associated with issues, such as the source code repositories 130, the external ticket database 125E, the internal ticket database 125Is, the source code 124, a proprietary source code database, source code 124 posted on a website, and/or the like. The source(s) 201 may be local and/or on the network 110. For example, the sources 201 may come from different source code projects that comprise multiple software components with multiple source code files that reside on the network 110 and/or on the code management system 120.

The tickets 202 are tickets about issues in source code 124. For example, the tickets 202 may be tickets 202 associated with the source code 124 on the code management system 120 (e.g., in the internal ticket database 125I), tickets 202 associated with the source code repositories 130 (e.g., in the external ticket database 125E), and/or the like.

The pull requests 203 have information associated with the tickets 202. The pull requests 203 have description information about an issue, comments about the issue, affected source code 124, potential changes/fixes, and/or the like. The pull requests 203 may be part of a ticket 202. There may be multiple pull requests associated with a ticket 202.

The source code comments 204 are comments in the source code 124. For example, the source code comments 204 may be comments in the source code 124 provided by the developer 102. The source code comments 204 may indicate that a particular issue was fixed, may include information about how the issue was resolved, may indicate who fixed a particular issue, and/or the like. The sentence encodings 205 are an output of the sentence transformation algorithm 123. For example, the sentence encodings 205 may be floating point vectors from a vector AI algorithm, values from a pattern matching algorithm, values from a string comparison algorithm, an Euclidean distance, and/or the like.

The issue management system 126 gets the information from the sources 201, which includes the tickets 202, the pull requests 203, the source code comments 204, and/or the like. This information is then used as an input into the text summarization algorithm 122. The output of the text summarization algorithm 122 may be a single text (e.g., the tickets 202/pull requests 203/source code comments 204 are combined into a single text) or may comprise multiple texts. Multiple texts may be summarized in different ways. For example, each ticket 202 and its associated pull request(s) 203 may be summarized into one sentence (a single paragraph) and the source code comments 204 may be summarized into a separate sentence (e.g., a single paragraph). The information that is input into the text summarization algorithm 122 may be divided into multiple text summarizations in other ways, such as based on descriptions, affected sources, code change types, issue types, and/or the like. The output of the text summarization algorithm 122 is then converted by the sentence transformation algorithm 123 to produce the sentence encodings 205. For example, a vector AI algorithm 123 may be used to produce floating point vectors (the sentence encodings 205) based on a single sentence generated by the text summarization algorithm 122.

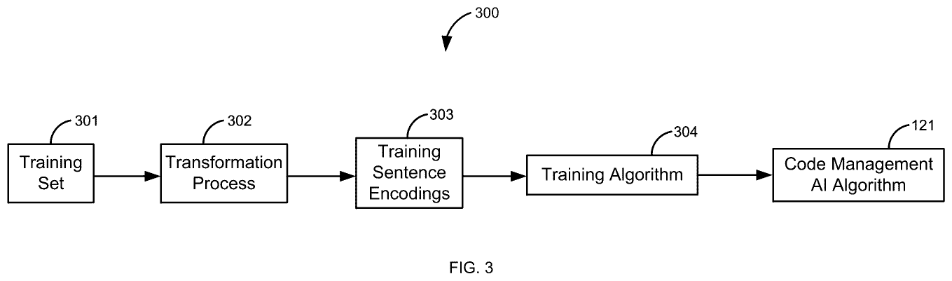

FIG. 3 is a block diagram of a third illustrative system 300 for training a code management AI algorithm 121. The third illustrative system 300 comprises a training set 301, a transformation process 302, training sentence encodings 303, a training algorithm 304, and the code management AI algorithm 121.

The training set 301 comprises information that is used to train the code management AI algorithm 121. For example, the training set 301 may include information from the source code repositories 130, from the external ticket database(s) 125E, from the internal ticket database(s) 125I, from the source code 124, from other sources on the network 110, and/or the like. The training set 301 may comprise different components (source code 124) of different projects. The training set 301 is used an input (e.g., a source 205 like in FIG. 2) to the transformation process 302. The transformation process 302 may work the same way as the process described in FIG. 2 to take the training set 301 to produce the training sentence encodings 303. The training set 301 (e.g., tickets 202, pull requests 203, and/or source code comments 204) are used as an input into the text summarization algorithm 122/sentence transformation algorithm 123 to produce the training sentence encodings 303.

The training algorithm 304 is then used to train the code management algorithm 121. For example, the training algorithm 304 may be a backpropagation algorithm that trains the code management AI algorithm 121 based on the training sentence encodings 303.

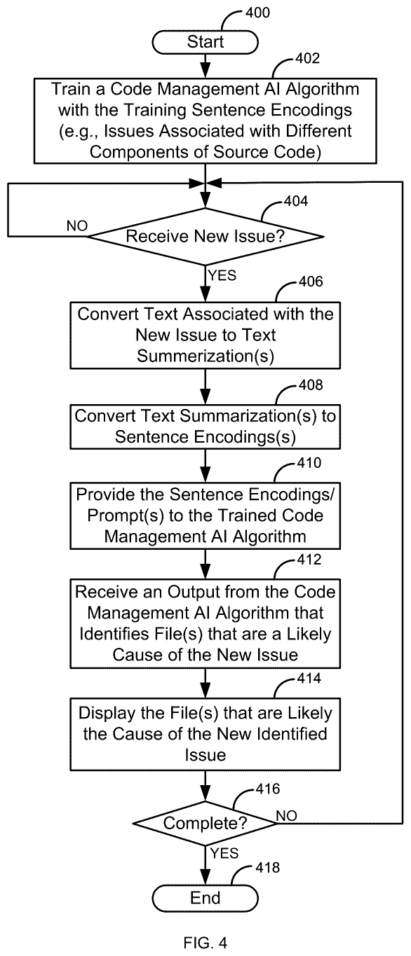

FIG. 4 is a flow diagram of a process for using AI to recommend solutions to issues and to fix issues in source code 124. Illustratively, the communication devices 101A-101N, the code management system 120, the code management AI algorithm 121, the text summarization algorithm 122, the sentence transformation algorithm 123, the internal ticket database(s) 125I, the issue management system 126, the external ticket databases(s) 125E, the source code repositories 130, and the training algorithm 304 are stored-program-controlled entities, such as a computer or microprocessor, which performs the method of FIGS. 4-6 and the processes described herein by executing program instructions stored in a computer readable storage medium, such as a memory (i.e., a computer memory, a hard disk, and/or the like). Although the methods described in FIGS. 4-6 are shown in a specific order, one of skill in the art would recognize that the steps in FIGS. 4-6 may be implemented in different orders and/or be implemented in a multi-threaded environment. Moreover, various steps may be omitted or added based on implementation.

The process starts in step 400. The issue management system 126 trains the code management AI algorithm 121, in step 402, with the training sentence encodings 303 using the training algorithm 304. For example, step 400 may work as described in FIG. 3. While step 402 is shown going to step 404. The process of step 402 may be asynchronous to the process described in steps 404-416. For example, step 402 may occur weeks before the process of waiting to receive a new issue in step 404 starts.

The issue management system 126 waits, in step 404, to receive a new issue. For example, a developer 102 may enter a new ticket 202, via the internal ticket database 125I, for a for an issue (e.g., a software vulnerability) in the source code 124. If a new issue has not been received in step 404, the process of step 404 repeats.

Otherwise, if a new issue has been received in step 404, the text summarization algorithm 122 converts text associated with the new issue to text summarization(s) in step 406. The sentence transformation algorithm 123 converts the text summarization(s) associated with the new issue into sentence encodings 205 in step 408. The issue management system 126 provides the sentence encodings 205 to the trained code management AI algorithm 121 in step 410. In addition to the sentence encodings 205, additional prompt information may be provided to the trained code management AI algorithm 121.

In addition to the sentence encodings 205, other information may be provided to the trained code management AI algorithm 121 in step 410. For example, text prompts may be provided in addition to the sentence encodings 205 that request the trained code management algorithm 121 to identify source code files that are a likely cause of a particular issue. An illustrative input prompt may be to “Identify source code file(s) that are likely the cause of issue X in the software application A with the attached sentence encodings” (with the sentence encoding 205 of the issue also being provided as an input at the same time).

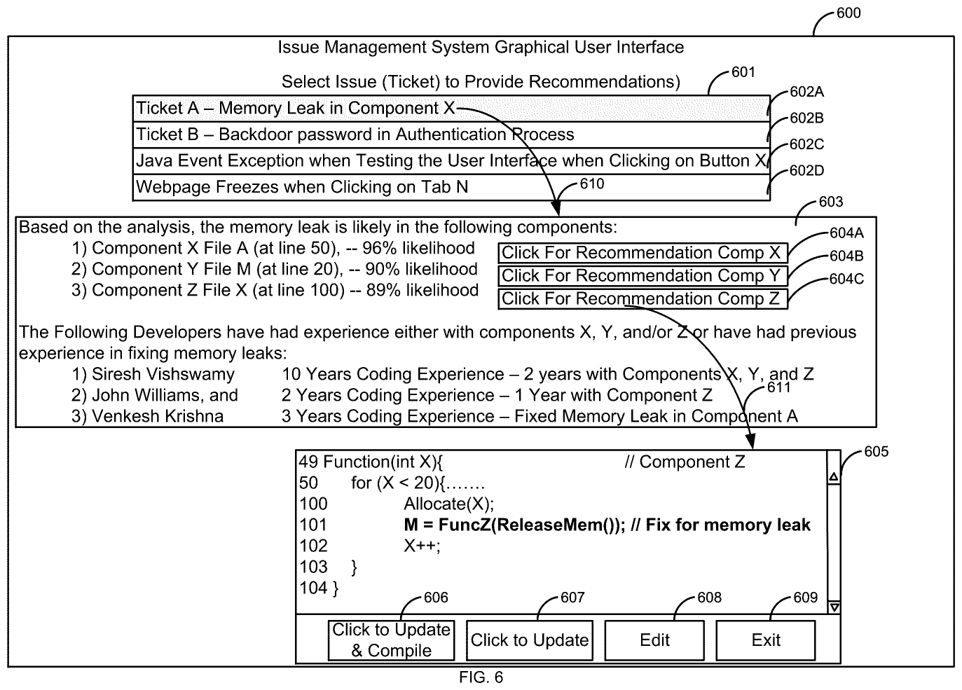

Based on the sentence encodings 205 and optionally the prompt text, the issue management system 126 receives an output from the code management AI algorithm 121 that identifies file(s) that are a likely cause of the issue in step 412. The issue management system 126 displays the file(s) that are likely the cause of the new identified issue in step 414. For example, the issue management system 126 may generate a user interface in that has the identified file(s) as shown in FIG. 6.

The issue management system 126 determines, in step 416, if the process is complete. If the process is not complete in step 416, the process goes to step 404 to wait to receive a new issue. Otherwise, if the process is complete in step 416, the process ends in step 418.

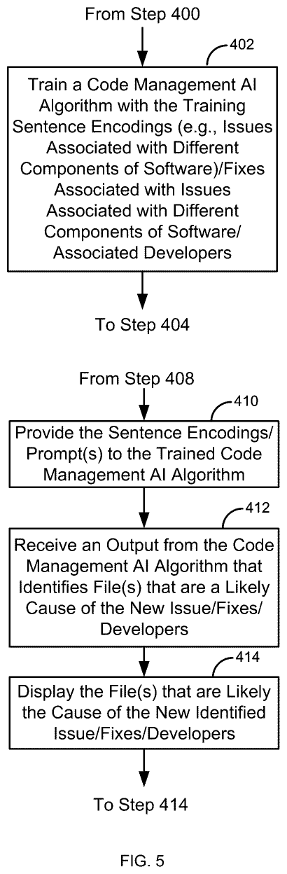

FIG. 5 is a flow diagram of a process for using AI to recommend solutions to issues and to fix issues in source code 124 along with identifying fixes and potential developers to fix the source code 124. FIG. 5 is another embodiment for steps 402, 412, and 414.

In FIG. 5, step 402 further comprises where the training sentence encodings 303 also include fixes associated with the issue. For example, if the issue is a buffer overflow issue, an associated fix for the buffer overflow issue may be provided as part of the training sentence encodings 303 in step 402. By adding a large number of fixes, the code management AI algorithm 121 can not only identify the likely source code 124 that need to be fixed, the code management AI algorithm 121 can also suggests ways to fix the issue(s) that were identified by the code management AI algorithm 121.

In addition, the training sentence encodings 303 may include information associated with the developers 102A-102N. For example, the internal ticket database 125I may have information associated with the developers 102A-102N, what source code 124 file(s) the developers 102A-102N have worked on, experience that the developers 102A-102N have in coding software. This information may be in comments in the source code 124. For example, one of the developers 102 may have provided comments that names the developer 102 who fixed a bug or wrote a specific component of source code 124. The developer information may be part of a pull request 203 where the developer 102 closed the ticket 202 about a bug in a specific software component.

In FIG. 5, step 410 may have additional prompts along with the sentence encodings 205. For example, text prompts may be provided in addition to the sentence encodings 205 that request the trained code management algorithm 121 to not only identify the file(s), but to also identify likely fixes to the source code 124, identify the best developers to fix the issue, and/or the like. An illustrative input prompt may be to “Identify source code file(s) that are likely the cause of issue X in the software application A, identify potential fixes to the identified source code files, and identify the best developers to fix the issue in the identified file(s) with the attached sentence encodings” (with the sentence encoding 205 of the issue also being provided as an input at the same time).

In FIG. 5, step 412 further comprises where the output of the code management AI algorithm 121 not only identifies the file(s) that are a likely cause of the new issue, but also identify potential fixes and developers 102 that are the best match to fix the new issue. For example, the output of the code management AI algorithm 121 may provide a patch for fix a Java exception in software component M in the source code 124 and name a specific developer 102 who has previously worked on the software component M.

In FIG. 5, step 414 not only displays the likely files, in addition, the likely fixes and/or best developers 102 to fix the issue are displayed. For example, a user interface may be provided that identifies that component M (componentM.java), has a patch to fix a Java exception and identifies developer X as the best candidate to fix the new issue. In addition, other information may be displayed, such as a severity of the new issue.

FIG. 6 is diagram of a user interface 600 that allows a developer 102 to efficiently identify solutions to issues 602 and to fix issues 602 in source code 124. The user interface 600 comprises an issue list 601, an analysis window 603, and a fix window 605.

The issue list 601 is a list of different issues 602 in the source code 124. For example, the issue list 601 may be for a specific project that is being used to develop a complex software application. The issue list 601 may come from a ticket 202 that was entered into the internal ticket database 125I. The issue list 601 comprises four issues (602A-602D): 1) a memory leak in component X, 2) a backdoor password in the authentication process, 3) a Java event exception in the user interface 600 when clicking on button X, and 4) a webpage freezes when clicking on tab N issue 602D.

If the developer 102 wants to learn more about a particular issue 602, the developer 102 can click on an issue 602 in the issue list 601. For example, the developer 102 has clicked on the issue 602A (memory leak) in step 610. This causes the analysis window 603 to be displayed to the developer 102 in the user interface 600. The analysis window 603 includes various types of information about the issue 602. For example, the analysis window 603 indicates that the component X (96% likelihood), the component Y (90% likelihood), and the component Z (89% likelihood) are likely associated with the memory leak. The analysis window 603 also indicates specific files of the component, and at what line in the file is where the issue 602 resides. For each component/file there is an associated recommendation button 604A-604C.

The developer 102 can click on an individual recommendation button 604 go to the source code 124 for the particular issue 602. For example, in FIG. 6, the developer 102 has clicked on the recommendation button 604C, in step 611, to open file X in the component Z in the fix window 605. The fix window 605 displays the source code 124 of component Z/file X at the point (line 100) where the likely fix needs to be made and the source code 124 for the likely fix (M=FuncZ(ReleaseMem( )); //Fix for memory leak). The fix is highlighted in the fix window 606. If the fix to the issue 602 is multiple lines of code, each line of the fix may be highlighted and/or in a different color. The fix window 605 gives the developer 102 multiple options. The developer 102 may click the button 606 to update and recompile the source code 124 for the component Z/file X or check for errors. The developer may click the button 607 to update the source code 124 for the component Z/file X with the fix. The developer 102 may edit the source code 124 for the component Z/file X by clicking on the edit button 608. The developer 102 may close the fix window 605 by clicking the exit button 609.

Although not shown in FIG. 6, the developer 102, from the analysis window 603 may assign/recommend a specific developer 102 to fix/manage the issue.

Although not shown, the developer 102 may configure the system to automatically fix an issue 602. For example, if the likelihood is 100%, the issue management system 126 may automatically update the source code 124. For example, the issue management system 126 may automatically recompile the source code with the fix, run the source code 124 with the fix in an interpreter (e.g., a Java Virtual Machine), check the source code 124 with the fix to determine any compilation issues, run tests against the application, and/or the like.

As one can see, the user interface 600 dramatically simplifies the existing process of easily identifying issues 602 and fixing the issues 602. In the past, the developer 102 would first have to open the internal ticket database 125I, identify the issue 602 in the internal ticket database 125I, and determine who is likely the best developer 102 to fix the issue 602. Then the developer 102 would search through the source code 124 (e.g., in an Integrated Development Environment (IDE)) to determine what components/files the issue 602 resides, which could take several more hours. With the user interface 600, withing a matter of a few simple steps, the developer 102 can now quickly identify the issue 602, have source code 124 to fix the issue 602/edit and recompile the source code 124 all within a single environment. This makes the user interface 600 is much more efficient than what currently exists because the developer 102 would have to open multiple tools, manually figure out what components/files are affected, and try to determine how to fix the issue 602. With the user interface 600, this can be completed in a few seconds/minutes.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
train an Artificial Intelligence (AI) algorithm using a training set, wherein the training set is a set of training sentence encodings of issues associated with different components of source code;
receive a new identified issue associated with a base of source code;
convert text associated with the new identified issue into a set of one or more sentence encodings;
provide the set of one or more sentence encodings to the trained AI algorithm;
in response to providing set of one or more sentence encodings to the trained AI algorithm, receive an output from the AI algorithm that identifies one or more files that are likely a cause of the new identified issue; and
generate for display, in a user interface, the one or more files that are the likely cause of the new identified issue.

2. The system of claim 1, wherein the set of one or more sentence encodings are one of: vectors of sentences, matched patterns, string comparisons, and an Euclidean distance.

3. The system of claim 1, wherein the set of training sentence encodings of issues associated with different components of source code comprise source code that fixes issues associated with the different components of source code, and wherein the output from the AI algorithm further comprises a fix to the new identified issue.

4. The system of claim 3, wherein the user interface displays source code of the one or more files that are likely a cause of the new identified issue and the fix to the new identified issue in the source code of the one or more files that are likely a cause of the new identified issue.

5. The system of claim 4, wherein a developer, from the user interface, can do at least one of the following options: select a button to automatically incorporate the fix to the new identified issue in the source code of the one or more files that are likely a cause of the new identified issue, view a likelihood of how the fix to the identified issue in the source code of the one or more files will resolve the new identified issue, view a likelihood of how the one or more files are the cause of the new identified issue, and recommend one or more developers who have experience with the identified one or more files that are likely the cause of the new identified issue.

6. The system of claim 3, wherein the fix is automatically incorporated into the one or more files that are the likely cause of the new identified issue.

7. The system of claim 6, wherein in response to the fix being automatically incorporated into the one or more files that are the likely cause of the new identified issue do at least one of: recompile the base of source code with the fix to the new identified issue and reinterpret the base of source code with the fix to the new identified issue.

8. The system of claim 1, wherein the set of training sentence encodings of issues associated with different components of source code comprises: tickets for issues, pull requirements for the issues, comments from the different components of source code, and fixes to the issues in the different components of source code.

9. The system of claim 1, wherein, before the AI algorithm is trained, the set of training sentence encodings of issues associated with different components of source code has been run through a summarization algorithm and a vector AI algorithm.

10. The system of claim 1, wherein providing the set of one or more sentence encodings to the trained AI algorithm further comprises a text prompt that instructs the trained AI algorithm to: identify the one or more files that are likely to identify the cause of the new identified issue, to identify likely fixes to source code in the identify the one or more files that are likely to identify the cause of the new identified issue, and to identify the best developers to fix the issue.

11. A method comprising:
training, by a microprocessor, an Artificial Intelligence (AI) algorithm using a training set, wherein the training set is a set of training sentence encodings of issues associated with different components of source code;
receiving, by the microprocessor, a new identified issue associated with a base of source code;
converting, by the microprocessor, text associated with the new identified issue into a set of one or more sentence encodings;
providing, by the microprocessor, the set of one or more sentence encodings to the trained AI algorithm;
in response to providing set of one or more sentence encodings to the trained AI algorithm, receiving, by the microprocessor, an output from the AI algorithm that identifies one or more files that are likely a cause of the new identified issue; and
generating for display, in a user interface, by the microprocessor, the one or more files that are the likely cause of the new identified issue.

12. The method of claim 11, wherein the set of one or more sentence encodings are one of: vectors of sentences, matched patterns, string comparisons, and an Euclidean distance.

13. The method of claim 11, wherein the set of training sentence encodings of issues associated with different components of source code comprise source code that fixes issues associated with the different components of source code, and wherein the output from the AI algorithm further comprises a fix to the new identified issue.

14. The method of claim 13, wherein the user interface displays source code of the one or more files that are likely a cause of the new identified issue and the fix to the new identified issue in the source code of the one or more files that are likely a cause of the new identified issue.

15. The method of claim 14, wherein a developer, from the user interface, can do at least one of the following options: select a button to automatically incorporate the fix to the new identified issue in the source code of the one or more files that are likely a cause of the new identified issue, view a likelihood of how the fix to the identified issue in the source code of the one or more files will resolve the new identified issue, view a likelihood of how the one or more files are the cause of the new identified issue, and recommend one or more developers who have experience with the identified one or more files that are likely the cause of the new identified issue.

16. The method of claim 13, wherein the fix is automatically incorporated into the one or more files that are the likely cause of the new identified issue.

17. The method of claim 16, wherein in response to the fix being automatically incorporated into the one or more files that are the likely cause of the new identified issue do at least one of: recompile the base of source code with the fix to the new identified issue and reinterpret the base of source code with the fix to the new identified issue.

18. The method of claim 11, wherein the set of training sentence encodings of issues associated with different components of source code comprises: tickets for issues, pull requirements for the issues, comments from the different components of source code, and fixes to the issues in the different components of source code.

19. The method of claim 11, wherein, before the AI algorithm is trained, the set of training sentence encodings of issues associated with different components of source code has been run through a summarization algorithm and a vector AI algorithm.

20. A non-transient computer readable medium having stored thereon instructions that cause a processor to execute a method, the method comprising instructions to:
train an Artificial Intelligence (AI) algorithm using a training set, wherein the training set is a set of training sentence encodings of issues associated with different components of source code;
receive a new identified issue associated with a base of source code;
convert text associated with the new identified issue into a set of one or more sentence encodings;
provide the set of one or more sentence encodings to the trained AI algorithm;
in response to providing set of one or more sentence encodings to the trained AI algorithm, receive an output from the AI algorithm that identifies one or more files that are likely a cause of the new identified issue; and
generate for display, in a user interface, the one or more files that are the likely cause of the new identified issue.
